(19) United States
(12) Patent Application Publication
(10) Pub. No.: US 2026/0016307 A1
(43) Pub. Date: Jan. 15, 2026

(54) SYSTEMS AND METHODS FOR OPTIMIZING VEHICLE MOVEMENT AND VEHICLE CHARGING

(71) Applicant: Ford Global Technologies, LLC, Dearborn, MI (US)

(72) Inventors: Ahmadreza Mahmoudzadeh, League City, TX (US); Mahmood Tabesh, Northville, MI (US); Hossein Sartipizadeh, Centennial, CO (US); Ryan O'Gorman, Beverly Hills, MI (US)

(73) Assignee: Ford Global Technologies, LLC, Dearborn, MI (US)

(21) Appl. No.: 18/770,096

(22) Filed: Jul. 11, 2024

(51) Int. Cl. G01C 21/34; G01C 21/36

(52) U.S. Cl. CPC G01C 21/3484; G01C 21/343; G01C 21/3461; G01C 21/3476; G01C 21/3617; G01C 21/3685

(57) ABSTRACT

A charging management system including a transceiver and a processor is disclosed. The transceiver may receive historical inputs associated with a vehicle and user preferences associated with a vehicle user. The processor may determine a routine travel behavior of the vehicle based on the historical inputs, and an expected set of destinations from a plurality of destinations that the vehicle is expected to visit in a preset time duration based on the routine travel behavior. The expected set of destinations may include a first destination associated with a first destination tag, and a second destination associated with a second destination tag. The processor may further identify an optimal set of destinations, from the plurality of destinations, based on user preferences and routine travel behavior. The optimal set of destinations may include a third destination associated with the first destination tag, and a fourth destination associated with the second destination tag.

### FIELD

The present disclosure relates to electric vehicles (EVs), and more particularly, to systems and methods for optimizing vehicle movement and vehicle charging.

### BACKGROUND

With increasing number of electric vehicles (EVs), the EV landscape is rapidly evolving. An EV operates on electric energy, and a vehicle user is required to charge the vehicle battery regularly to ensure uninterrupted vehicle operation. The vehicle user may charge the EV at the user's home or at public charging stations. Many-a-times, the vehicle user may charge the vehicle at one or more destinations where the user typically visits and/or parks the vehicle. For example, the user may charge the vehicle at a gym, a restaurant, an office building, a grocery store, and/or the like, where the user typically parks the vehicle.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts example recommendations to optimize vehicle charging in accordance with the present disclosure.

FIG. 3 depicts an example recommendation of a next destination in accordance with the present disclosure.

FIG. 4 depicts a flow diagram of an example method for optimizing vehicle movement and vehicle charging in accordance with the present disclosure.

### DETAILED DESCRIPTION

### Overview

The present disclosure describes a charging management system (“system”) that determines a routine travel behavior of a vehicle (e.g., an electric vehicle), and provides one or more recommendations to re-orient the routine or recommend destination(s) that the vehicle may visit, based on vehicle user's preferences and the routine travel behavior. In some aspects, the system may obtain historical inputs associated with the vehicle, and determine the routine travel behavior of the vehicle based on the historical inputs. The routine travel behavior may include, for example, a charging pattern, a parking pattern, a travel pattern, and/or the like associated with the vehicle. As an example, the system may determine charging locations/times at which the vehicle typically gets charged, parking locations/times at which the vehicle is typically parked, travel locations/times to/at which the vehicle typically travels, and/or the like. In addition, the routine travel behavior may include travel frequency, travel routes, energy consumption patterns, etc., associated with the vehicle.

Responsive to determining the routine travel behavior, the system may determine an expected set of destinations, from a plurality of destinations, that the vehicle may visit in a preset time duration (e.g., in a day) based on the routine travel behavior. The expected set of destinations may include multiple destinations that the vehicle may visit sequentially in the preset time duration. For example, the system may determine that the vehicle is expected to visit a gym, a shopping center, a restaurant daily in a sequence, based on the routine travel behavior. Responsive to determining the expected set of destinations, the system may generate a recommendation based on the user preferences and the routine travel behavior. In some aspects, the recommendation may be associated with re-orienting routine associated with the vehicle (e.g., to recommend an updated sequence to visit the expected set of destinations). In further aspects, the recommendation may include an optimal set of destinations for the vehicle to visit in the preset time duration, determined based on the user preferences and the routine travel behavior. The optimal set of destinations may include multiple destinations that may different from the expected set of destinations. In some aspects, some destinations of the optimal set of destinations may be same as the destinations included in the expected set of destinations.

As described above, the system may identify the optimal set of destinations from the plurality of destinations, based on the user preference and the routine travel behavior. The user preferences may include, but are not limited to, preferences associated with high charging speed, reduced charging rates, charger reliability, charger availability, dedicated charging stations, rewarding destination (that may provide reward or incentive to the vehicle user), etc. In addition, the user preferences may include a preference to visit a predefined destination (e.g., a preference for a store of a specific brand over other brands). To identify the optimal set of destinations, the system may determine a set of destination tags (that are assigned based on destination types) associated with the expected set of destinations, and may identify the optimal set of destinations from each of the set of destination tags. In further aspects, the system may determine a route that the vehicle may take to visit the expected set of destination, and may identify the optimal set of destinations from the determined route. Stated another way, the system may identify the optimal set of destinations that are in proximity to the expected set of destinations, so that the vehicle may not be required to substantially deviate its routine route to visit the optimal set of destinations.

In some aspects, the system may output the recommendation to re-orient the routine or visit the optimal set of destinations before the vehicle leaves a primary parking and charging destination associated with the vehicle (e.g., user's home). In further aspects, the system may output the recommendation in real-time based on the vehicle's current location (e.g., when the vehicle is parked at a destination, of the expected set of destinations). In the latter scenario, the system may determine the current location/destination and a current destination tag associated with the current destination, and predict the next destination and the next destination tag based on the current destination and the current destination tag. Based on the next destination and the next destination tag, the system may identify new location(s)/destination(s) associated with the next destination tag based on the user preferences and the routine travel behavior, and generate a recommendation for the user to visit the identified new location(s)/destination(s).

The present disclosure discloses a system and method that determines vehicle routine and optimizes vehicle charging. The system generates personalized or customized recommendations based on vehicle routine and user preferences, which enhances user's experience of visiting the destinations and charging the vehicle. In addition, the system identifies most rewarding destinations that meets the user preferences, and provides recommendation to visit such destinations. Further, the system outputs notifications/recommendations for the user before the vehicle leaves the primary parking and charging location or the vehicle's current location, which adds a dynamic layer of interaction with the vehicle user, which further enhances the user's decision-making process and experience.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

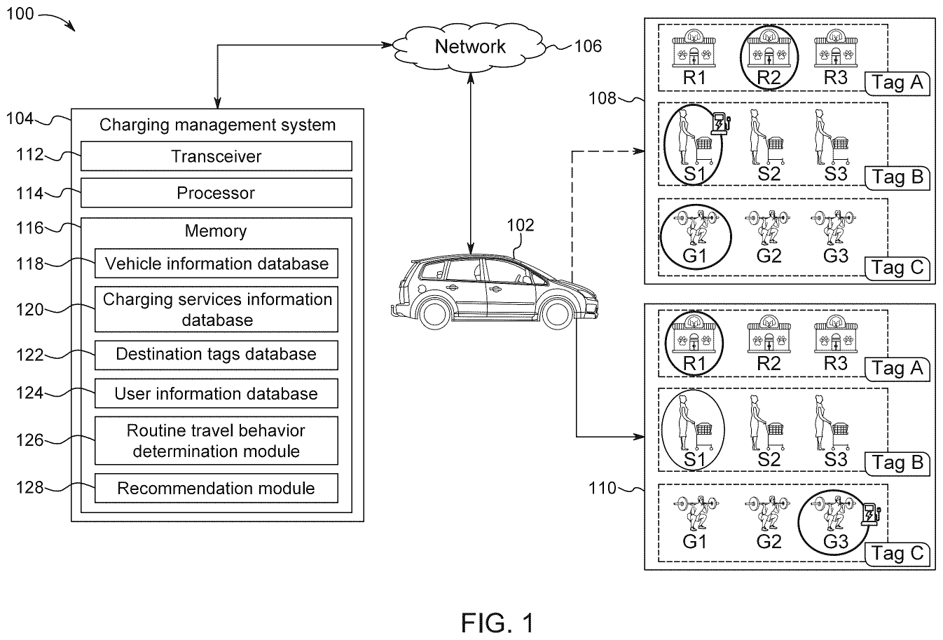

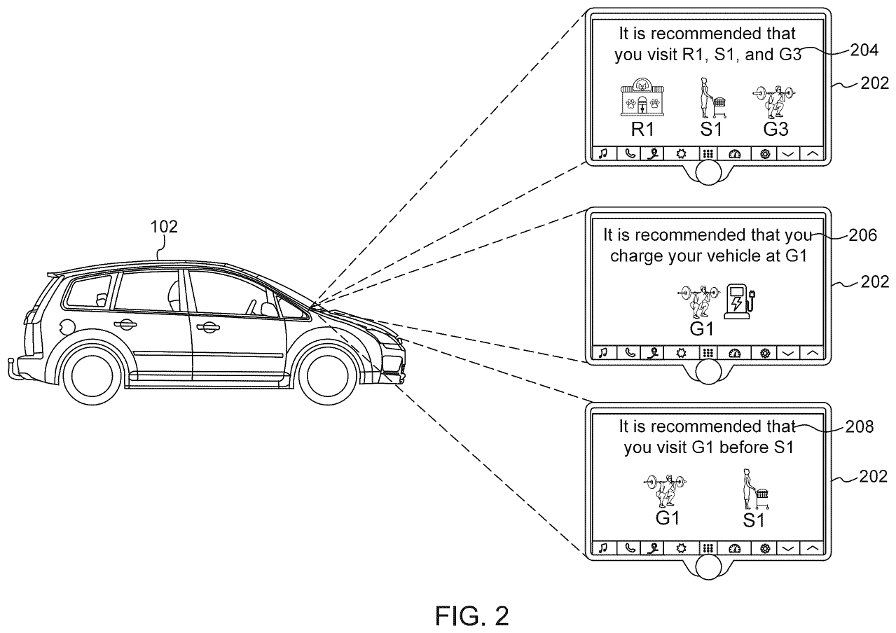

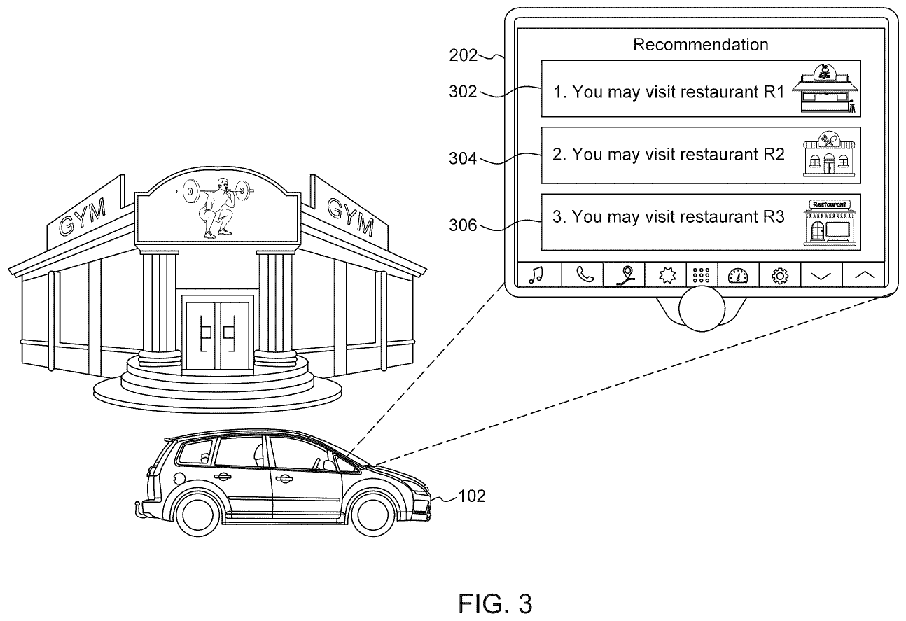

FIG. 1 depicts an example environment 100 in which techniques and structures for providing the systems and methods disclosed herein may be implemented. FIG. 1 will be described in conjunction with FIGS. 2 and 3.

The environment 100 may include a vehicle 102 that may be an Electric Vehicle (EV). The vehicle 102 may take the form of any passenger or commercial vehicle such as a car, a work vehicle, a crossover vehicle, a truck, a van, a minivan, a taxi, a bus, etc. Further, the vehicle 102 may be a manually driven vehicle, and/or may be configured to operate in a fully autonomous (e.g., driverless) mode or a partially autonomous mode.

The environment 100 may further include a charging management system 104 (or system 104) that may be communicatively coupled with the vehicle 102 via a network 106. The network 106, as described herein, illustrates an example communication infrastructure in which the connected devices discussed in various embodiments of this disclosure may communicate. The network 106 may be and/or include the Internet, a private network, public network or other configuration that operates using any one or more known communication protocols such as transmission control protocol/Internet protocol (TCP/IP), Bluetooth®, Bluetooth® Low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

In some aspects, the system 104 may be part of the vehicle 102. In other aspects, the system 104 may not be part of the vehicle 102, and may be located outside the vehicle 102. For example, in an exemplary aspect, the system 104 may be hosted on a server or a distributed computing system, which may be communicatively coupled with the vehicle 102 via the network 106.

The system 104 may be configured to obtain (and store) historical inputs associated with the vehicle 102. Examples of the historical inputs associated with the vehicle 102 include, but are not limited to, historical travel pattern or trip patterns (e.g., vehicle odometer readings, travel routes, etc.), historical charging patterns (e.g., charging locations/times), historical parking patterns (e.g., parking locations/times), and/or the like. In addition, the system 104 may be configured to obtain (and store) user preferences associated with a vehicle user of the vehicle 102. The user preferences may include, but are not limited to, preferences associated with high charging speed, reduced charging rates, a charging or charger availability (e.g., time durations at which the user prefers to charge the vehicle 102 or prefers to have a charger available), a charging or charger reliability, dedicated charging stations, one or more incentives or rewards that the user may receive for charging the vehicle 102 from the charging stations, and/or the like. In addition, the user preferences may include user interests to visit a specific or a predefined destination (e.g., a preference to visit a first grocery store over a second grocery store to buy groceries).

The system 104 may analyze the historical inputs and determine a routine travel behavior of the vehicle 102 based on the historical inputs. The vehicle's routine travel behavior may include a typical charging pattern, a parking pattern, and/or a travel pattern associated with the vehicle 102. Specifically, the routine travel behavior may include typical charging locations and associated time durations/times at which the vehicle 102 is charged on each day/week/month, parking locations and associated time durations/times at which the vehicle 102 is parked, travel locations or routes and associated time durations/times for which the vehicle 102 travels on each day/week/month, and/or the like. The system 104 may determine the routine travel behavior separately for each day (e.g., weekday or weekend), a week, a month, a season, during special times such as New Year, etc.

Responsive to determining the vehicle's routine travel behavior, the system 104 may determine or identify one or more destinations (e.g., an expected set of destinations 108), from a plurality of destinations, that the vehicle 102 may be expected to visit in a preset time duration (e.g., within a day) based on the routine travel behavior. The expected set of destinations 108 may include multiple destinations that the vehicle 102 may visit sequentially in the preset time duration. For example, the system 104 may determine that the vehicle 102 is expected to visit a retail store R2, a shopping store/center S1, and a gym G1 in the preset time duration based on the routine travel behavior, as shown in FIG. 1. In addition, the system 104 may determine/estimate a sequence in which the vehicle 102 may visit the expected set of destinations 108 based on the routine travel behavior. For example, the system 104 may estimate that the vehicle 102 may first visit the retail store R2, and then the shopping center S1, and finally the gym G1. In some aspects, the expected set of destinations 108 and/or the sequence to visit the expected set of destinations 108 may be same or different for different days. For example, the expected set of destinations 108 for weekdays and weekend may be different.

In some aspects, the plurality of destinations may be associated with a plurality of destination tags. The destination tags may be pre-assigned to the destinations by the system 104 (or an external server or computing system) based on the destination type of each destination, such that similar destinations are categorized under one destination tag. Thus, each tag may include one or more locations/destinations that may have the same or similar type. For example, retail stores R1-R3 may be categorized under a single destination tag, e.g., “Tag A”; shopping centers S1-S3 may be categorized under another single destination tag, e.g., “Tag B”; gyms G1-G3 may be categorized under yet another single destination tag, e.g., “Tag C”, as shown in FIG. 1.

In some aspects, responsive to determining the expected set of destinations 108 that the vehicle 102 is expected to visit in the preset time duration, the system 104 may determine a destination tag associated with each of the expected set of destinations 108. For instance, the system 104 may determine destination tags associated with the retail store R2, the shopping center S1, and the gym G1. As an example, the system 104 may determine that the retail store R2 is associated with the Tag A, the shopping center S1 is associated with the Tag B, and the gym G1 is associated with the Tag C.

In this manner, the system 104 may determine that the vehicle 102 may be expected to visit the retail store R2 associated with the Tag A, the shopping center S1 associated with the Tag B, and the gym G1 associated with the Tag C, in the day, based on the routine travel behavior. Since the expected set of destinations 108 may be different for different days, the destination tags that the vehicle 102 may be expected to visit may also be different for different days (and may be different within different time windows/durations). Further, the system 104 may estimate an expected or a routine charging destination, from the expected set of destinations 108, at which the vehicle 102 may be expected to get charged based on the routine travel behavior. For example, the system 104 may determine that the vehicle 102 is expected to get charged at the shopping center S1 associated with the Tag B, as shown in FIG. 1.

Responsive to estimating the expected set of destinations 108, the sequence of visit and the expected charging destination as described above, the system 104 may identify an optimal set of destinations 110, from the plurality of destinations, based on the user preferences and the routine travel behavior. The optimal set of destinations 110 may be those destinations that the vehicle 102 should visit (instead of the expected set of destinations 108), to optimize vehicle's charging (e.g., charging time) and/or to enhance vehicle charging experience (e.g., by getting rewards or benefits). Further, since the system 104 identifies the optimal set of destinations 110 based on user preferences or interests, the optimal set of destinations 110 are better suited to satisfy user's needs/requirements, and thus enhance user's charging experience.

In some aspects, the system 104 may identify the optimal set of destinations 110 such that the destinations 110 are associated with the same destination tags as the expected set of destinations 108. For instance, the system 104 may identify the optimal set of destinations 110 from the Tag A, the Tag B, and the Tag C, so that the user gets to visit all the types of destinations that the vehicle user typically visits. As an example, the system 104 may identify the optimal set of destinations 110 that includes the retail store R1 from the Tag A, the shopping center S1 from the Tag B, and the gym G3 from the Tag C, as shown in FIG. 1. The system 104 may then generate a recommendation based the identified optimal set of destinations 110, and output the recommendation (e.g., on a user device or a vehicle Human-Machine Interface (HMI)) including the information associated with the optimal set of destinations 110, so that the user may accordingly decide to visit the optimal set of destinations 110 instead of visiting the expected set of destinations 108. In some aspects, the information associated with the optimal set of destinations 110 may include geolocation details associated with the optimal set of destinations 110, details of charging services offered by the optimal set of destinations 110, proposed sequence to visit the optimal set of destinations 110, and/or the like. In further aspects, the system 104 may generate a recommendation to update the sequence to visit the expected set of destinations 108. In the latter scenario, all destinations in the optimal set of destinations 110 may be same as destinations in the expected set of destinations 108. Further details of the system 104 and the recommendation generation process are described later in the description below.

The system 104 may include a plurality of components including, but not limited to, a transceiver 112, a processor 114, and a memory 116, which may be communicatively coupled with each other. The transceiver 112 may be configured to transmit and receive the information or data to/from the vehicle 102 and/or other systems/servers/devices that may be communicatively coupled with the system 104 via the network 106. For example, the transceiver 112 may receive the historical inputs associated with the vehicle 102 directly from the vehicle 102, or from an external server (not shown). In addition, the transceiver 112 may receive the information about charging services associated with or offered by the plurality of destinations from an external server (not shown) or directly from computing systems associated with the plurality of destinations. Examples of the charging services include, but are not limited to, charging speed, charging rates, charging price, charging or charger availability status, charging or charger reliability, any charging rewards/benefits/incentives provided by the destinations for vehicle charging, and/or the like. Further, the transceiver 112 may obtain the user preferences from a user interface associated with a user device (e.g., a mobile device, a laptop, a tablet, a smartwatch, or any device having communication capability) or a Human-Machine Interface (HMI) of the vehicle 102. The examples of the user preferences are described above. In addition, the transceiver 112 may obtain user's objective or purpose to visit a particular destination (e.g., the purpose to visit the shopping center S1 may be shopping an item, the purpose to visit the gym G1 may be exercising, and/or the like). The transceiver 112 may obtain the user's objective or purpose from the user interface. For example, the transceiver 112 may transmit a request to the vehicle user to provide the user's objective or purpose to visit a destination when the vehicle 102 visits a destination.

The processor 114 may be in communication with one or more memory devices in communication with the respective computing systems (e.g., the memory 116 and/or one or more external databases not shown in FIG. 1). The processor 114 may utilize the memory 116 to store programs in code and/or to store data for performing aspects in accordance with the disclosure. The memory 116 may be a non-transitory computer-readable storage medium or memory storing a program code that enables the processor 114 to perform operations in accordance with the present disclosure. The memory 116 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

The memory 116 may include a plurality of databases and modules including, but not limited to, a vehicle information database 118, a charging services information database 120, a destination tags database 122, a user information database 124, a routine travel behavior determination module 126, a recommendation module 128, and/or the like. The vehicle information database 118 may store the historical inputs associated with the vehicle 102 that the system 104 obtains from the vehicle 102 or the external server. The charging services information database 120 may store information about with the charging services associated with the plurality of destinations. The destination tags database 122 may store the mapping of the plurality of destinations with the plurality of destination tags. The user information database 124 may store the user preferences described above. In some aspects, the user information database 124 may further store the user's objective or purpose to visit a particular destination. The routine travel behavior determination module 126 and the recommendation module 128 may be stored in the form of computer-executable instructions, and the processor 114 may be configured and/or programmed to execute the stored computer-executable instructions for performing functions/operations in accordance with the present disclosure.

In operation, the transceiver 112 may receive the historical inputs associated with the vehicle 102 directly from the vehicle 102 or the external server, and may store the historical inputs in the memory 116 (e.g., in the vehicle information database 118). In addition, the transceiver 112 may receive the user preferences associated with the vehicle user from the user interface, and store the user preferences in the memory 116 (e.g., in the user information database 124).

The processor 114 may obtain the historical inputs and the user preferences from the transceiver 112 or the memory 116. Responsive to obtaining the historical inputs, the processor 114 may process and analyze the historical inputs, and determine the routine travel behavior associated with the vehicle 102 based on the historical inputs, by executing the instructions stored in the routine travel behavior determination module 126. As described above, the routine travel behavior may include the charging pattern, the parking pattern, the travel pattern, and/or the like associated with the vehicle 102.

Responsive to determining the routine travel behavior, the processor 114 may determine the expected set of destinations 108, from the plurality of destinations, that the vehicle 102 is expected to visit in the preset time duration (e.g., the next day) based on the routine travel behavior. The process of determining the expected set of destinations 108 based on the routine travel behavior is described later in the description below.

In addition to determining the expected set of destinations 108, the processor 114 may determine the destination tags associated with the expected set of destinations 108. As an example, the expected set of destinations 108 may include a first destination associated with a first destination tag, a second destination associated with a second destination tag, a third destination associated with a third destination tag, and so on. The first destination tag may be different from the second destination tag, which in turn may be different from the third destination tag. For instance, the processor 114 may determine that the vehicle 102 is expected to visit the retail store R2 associated with the Tag A, the shopping center S1 associated with the Tag B, and the gym G1 associated with the Tag C, in the day (e.g., when the vehicle 102 is about to commence the journey on the day), based on the routine travel behavior.

In some aspects, the processor 114 may use a mapping of the plurality of destinations with a plurality of destination tags, to determine the destination tags associated with the expected set of destinations 108 described above. The mapping may be generated by the processor 114 itself, or may be obtained from an external server. When the processor 114 itself generates the mapping, the processor 114 first identifies a destination type for each of the plurality of destinations, and then categorizes the plurality of destinations into the plurality of destination tags based on the respective destination types. The processor 114 then stores the mapping of the plurality of destinations with the plurality of destination tags in the memory 116 (e.g., in the destination tags database 122). To determine the first, the second and the third destination tags described above, the processor 114 may obtain/fetch the mapping from the destination tags database 122, and then determine the destination tags corresponding to the first, second and third destinations.

In some aspects, to determine the expected set of destinations 108 that the vehicle 102 may visit in the day, the processor 114 may first determine most visited locations associated the vehicle 102, from the plurality of destinations, for each day, based on the routine travel behavior. Based on the determination of the most visited locations, the processor 114 may determine the expected set of destinations 108 from the most visited locations based on the routine travel behavior. The most visited locations may be those locations where the vehicle 102 is parked for a time duration longer than a predefined time duration (e.g., for at least 10-15 minutes), and the frequency of visits to such locations is greater than a predefined frequency threshold (e.g., at least 4-5 times in a week or a month). In some aspects, the most visited locations may include the most visited parking and charging locations such as home, public charging stations, etc. In additional aspects, the most visited locations may include other locations visited by the vehicle 102 such as a gym, a retail store, a restaurant, an office location, etc. In some aspects, the processor 114 may use a machine learning-based clustering method/module (e.g., Density-Based Spatial Clustering of Applications with Noise (DBSCAN)) to determine the most visited locations. The machine-learning module/processor 114 may receive the recently visited locations (e.g., a few weeks of historical data) associated with the vehicle 102 as input, and may analyze geospatial data of parking and charging to identify the most visited locations.

Responsive to determining the most visited locations, the processor 114 may determine/select a primary parking and charging location from the most visited locations. The primary parking and charging location may be a main location at which the vehicle 102 spends the maximum amount of time in parking and charging on each day, such as home. Responsive to determining the primary parking and charging location, the processor 114 may estimate, a future departure time from the primary parking and charging location (e.g., for the morning of next day) and a future arrival time at the primary parking and charging location (e.g., for the evening of next day) based on the routine travel behavior. In addition, the processor 114 may estimate a future departure/arrival time at any destination (such as the first destination) in the preset time duration.

The processor 114 may further estimate a plurality of probabilities of parking the vehicle 102 at each of the most visited destinations at each time based on the routine travel behavior. In an exemplary aspect, the processor 114 may use the machine-learning module described above to analyze the parking and charging data included in the historical inputs associated with the vehicle 102, and predict/generate Parking Probability Profiles (PPP) for the vehicle 102. The PPP may be a graph that indicates the probability of a parking event at any location. The processor 114 may measure the probability of parking the vehicle 102 at each timeslot by using any analytical method including, but not limited to, a heuristic method, a time series prediction method, a pattern prediction method, machine learning, large language model (LLM) methods, and/or the like.

Responsive to generating the PPP for the vehicle 102 for each time as described above, the processor 114 may set a threshold to ascertain or detect a parking event at each destination. In some aspects, the processor 114 may dynamically set the threshold based on the vehicle's routine travel behavior, or specifically based on a vehicle's travel frequency (which may be part of the routine travel behavior). The travel frequency, as described in the present disclosure, may mean a count of time durations or a total amount of time duration in a day for which the vehicle 102 is traveling and is not parked/getting charged.

Responsive to setting the threshold, the processor 114 may compare each probability with the threshold. Based on the comparison, the processor 114 may determine that the probability of parking the vehicle 102 at a destination (e.g., the first destination) at a future time slot may be greater than the threshold. The processor 114 may further determine that the vehicle 102 is expected to park at the first destination during the future time slot based on a determination that the probability is greater than the threshold. In some aspects, the processor 114 may perform such determination of probability for each destination before the vehicle 102 leaves the primary parking and charging location (or the user's home). For example, the processor 114 may determine that the vehicle 102 is expected to park at the first destination (e.g., the retail store R2) at 7:00 AM, as the corresponding probability may be greater than the threshold. The processor 114 may further determine the destination tag (e.g., the first destination tag or the Tag A) associated with the first destination based on the mapping stored in the destination tags database 122, as described above.

When the processor 114 determines that the vehicle 102 is expected to park at the first destination (e.g., the retail store R2), the processor 114 may predict a next destination (e.g., the second destination, such as the shopping center S1) that the vehicle 102 is expected to visit after the first destination based on the routine travel behavior. In addition, the processor 114 may predict/determine the second destination tag (e.g., the Tag B) associated with the second destination based on the mapping stored in the destination tags database 122. Similarly, the processor 114 may determine the third destination (e.g., the gym G1) and its associated third destination tag (e.g., the Tag C), when the processor 114 determines that the vehicle 102 is expected to park at the second destination. The processor 114 may estimate the expected set of destinations 108 based on the prediction of the second destination (and the third destination) and the determination that the vehicle 102 is expected to park at the first destination (and the second destination). In some aspects, the processor 114 may also determine a route from the first destination to the second destination, and/or from the second destination to the third destination.

Responsive to determining the expected set of destinations 108 (and their corresponding destination tags) as described above, the processor 114 may identify and/or select the optimal set of destinations 110 from the plurality of destinations. In some aspects, the processor 114 may identify the optimal set of destinations 110 in the route from the first destination to the second destination, and/or from the second destination to the third destination. For example, the processor 114 may determine the optimal set of destinations 110 in the route from the retail store R2 to the shopping center S1, and/or the route from the shopping center S1 to the gym G1. In some aspects, the processor 114 may identify the optimal set of destinations 110 based on the user preferences and the routine travel behavior. In further aspects, the processor 114 may identify the optimal set of destinations 110 that are associated with the same destination tags as the destination tags associated with the expected set of destinations 108. For example, the optimal set of destinations 110 may include a fourth destination associated with the first destination tag (e.g., the Tag A), a fifth destination associated with the second destination tag (e.g., the Tag B), and a sixth destination associated with the third destination tag (e.g., the Tag C). Stated another way, the processor 114 may identify the optimal set of destinations 110 from the Tag A, the Tag B, and the Tag C. In some aspects, the fourth destination may be different from the first destination, and/or the second destination may be different from the fifth destination, and/or the third destination may be different from the sixth destination. Stated another way, in some aspects, at least one of the first, second and third destinations may be different from the fourth, fifth and sixth destinations. As an example, the system 104 may identify the optimal set of destinations 110 that includes the retail store R1 from the Tag A, the shopping center S1 from the Tag B, and the gym G3 from Tag C. In other aspects, the first, second and third destinations may be same as the fourth, fifth and sixth destinations; however, the sequence of visiting these destinations may be different in the optimal set of destinations 110, as described later below.

To identify the optimal set of destinations 110, the processor 114 may determine a first group of destinations (from the plurality of destinations) associated with the first destination tag (e.g., the Tag A), a second group of destinations associated with the second destination tag (e.g., the tag B), and a third group of destinations associated with the third destination tag (e.g., the tag C) based on the mapping stored in the destination tags database 122. The processor 114 may further obtain the information associated with charging services for the first, second and third groups of destinations from the charging services information database 120. Responsive to obtaining the information described above, the processor 114 may correlate the obtained information with the user preferences, and determine the fourth, fifth and sixth destinations from the first, second and third groups of destinations based on the correlation. In an exemplary aspect, the processor 114 may identify the fourth, fifth and/or sixth destinations based on the correlation such that these destinations provide better experience to the user for charging the vehicle 102 and are better aligned to the user's preferences, than the first, second and/or third destinations. As an example, when the user preference is for high charging speed, the processor 114 may compare the charging speeds associated with the expected set of destinations 108, with the first, second and third groups of destinations, and may select the optimal set of destinations 110 based on the comparison such that the fourth, fifth and/or sixth destinations provide better charging speed than the first, second and/or third destinations.

In addition, the processor 114 may select the optimal set of destinations 110 based on the user's preference/interest to visit a specific destination over any other destination. For example, the processor 114 may determine that the vehicle user generally visits a particular brand store. Based on such determination, the processor 114 may select the same brand store in other location or keep the same brand store in the optimal set of destinations 110, for user's convenience. Further, the processor 114 may obtain the user's objective or the purpose of visit to a particular destination from the user interface or the user information database 124, and may identify the optimal set of destinations 110 based on the user's objective or purpose. Furthermore, the processor 114 ensures that the fourth, fifth and sixth destinations are located on the same route or are disposed in proximity to the same route that is routinely traversed by the vehicle 102 (determined based on the routine travel behavior).

Responsive to identify the optimal set of destinations 110 as described above, the processor 114 may generate a recommendation for the user based on the optimal set of destinations 110, by executing the instructions stored in the recommendation module 128. The processor 114 may then output the recommendation on the user interface. In some aspects, the processor 114 may generate and output the recommendation to recommend to the user to visit the optimal set of destinations 110, instead of the expected set of destinations 108. The recommendation may include the information associated with the optimal set of destinations 110. The information may include geolocation details associated with the optimal set of destinations 110, details of charging services offered by the optimal set of destinations 110, proposed sequence to visit the optimal set of destinations 110, and/or the like. As an example, the processor 114 may output the recommendation on an HMI 202 to visit the retail store R1 (from the Tag A), the shopping center S1 (from the Tag B), and the gym G3 (from the Tag C), as shown in view 204 of FIG. 2.

In additional or alternative aspects, the processor 114 may determine a routine charging destination from the expected set of destinations 108 based on the routine travel behavior. The routine charging destination may be a destination at which the vehicle 102 typically gets charged or is expected to get charged on a day. For example, the processor 114 may determine that the vehicle 102 is expected to get charged at the shopping center S1 (associated with the Tag B), based on the routine travel behavior. Responsive to determining the routine charging destination, the processor 114 may determine or identify an updated charging destination from the expected set of destinations 108 (or the optimal set of destinations 110) based on the user preferences, and generate the recommendation that include the information associated with the updated charging destination. The information may include, for example, charging speed associated with the updated charging destination, charging rate, one or more incentives or rewards that are provided to users who charge their vehicles at the updated charging destination, and/or the like. As an example, the processor 114 may output the recommendation on the HMI 202, suggesting the user to charge the vehicle 102 at the gym G1 (associated with the Tag C), as shown in a view 206 (as the charging station at the gym G1 may be offering a higher charging speed than the charging speed available at the charging station of the shopping center S1).

In some aspects, the processor 114 may identify the updated charging destination from the Tag B (i.e., from the same destination tag that is associated with the routine charging destination). In other aspects, the processor 114 may identify the updated charging destination from the Tag A or the Tag C (i.e., from a different destination tag than the destination tag associated with the routine charging destination).

In further aspects, the processor 114 may estimate a sequence in which the vehicle 102 may visit the expected set of destinations 108 based on the routine travel behavior, and generate the recommendation based on the sequence and the user preferences. In this case, the optimal set of destination 110 may include the same destinations as the expected set of destinations 108; however, the sequence of visiting these destinations may be different in the optimal set of destination 110. In such cases, the recommendation may include an updated sequence to visit the expected set of destinations 108. For example, the processor 114 may output the recommendation to visit the gym G1 before the shopping center S1, as shown in a view 208 (as the shopping center S1 may be offering a reduced charging price at a later time). In some aspects, the processor 114 may output one or more recommendations, as shown in the views 204, 206, 208, before the vehicle 102 leaves the primary parking and charging location (e.g., the user home) or before the vehicle 102 commences the journey for the day.

In addition to providing the recommendation(s) before the vehicle 102 leaves the primary parking and charging location as described above, the processor 114 may provide real-time recommendations to the vehicle user when the vehicle 102 may be traveling or reaches a specific destination (e.g., the first destination). As an example, in this case, the processor 114 may first determine that the current location of the vehicle 102 is the first destination or the vehicle 102 is parked at the first destination (e.g., based on a real-time vehicle geolocation or based on the determination that the vehicle 102 is expected to park at the first destination based on the routine travel behavior, as described above). Responsive to determining the current location as the first destination, the processor 114 may predict, in real-time, the next location/destination (e.g., the second destination) that the vehicle 102 is expected to visit after the first destination, based on the determined expected set of destinations 108. The processor 114 may then predict the destination tag (e.g., the second destination tag) associated with the next destination based on the mapping obtained from the destination tags database 122. The processor 114 may then generate a recommendation for the user based on the prediction of the next destination and the user preferences. The recommendation may include a suggestion for a destination (e.g., the second destination) that the vehicle 102 may visit after the first destination, based on the user preferences and the routine travel behavior (and the user's objective or purpose to visit the second destination).

For example, the processor 114 may determine that the vehicle 102 may be parked at a gym at 7:00 AM, based on the real-time vehicle geolocation. The processor 114 may further determine that the vehicle user generally visits a restaurant R (e.g., a coffee shop) after spending one hour at the gym, based on the routine travel behavior. Based on such determination, the processor 114 may predict that the vehicle 102 may leave at 8:00 AM to visit the restaurant R. Responsive to such prediction, the processor 114 may determine one or more other restaurants (R1, R2, R3) as an alternative destination for the vehicle user from the second destination tag based on the user preferences, and generate/output the recommendation on the HMI 202 before the vehicle 102 departs the gym (around 8:00 AM) based on such determination. For example, the processor 114 may output the real-time recommendation that may include, but is not limited to, a recommendation to visit the restaurant R1, (as shown in a view 302 of FIG. 3), a recommendation to visit the restaurant R2, (as shown in a view 304), a recommendation to visit the restaurant R3, (as shown in a view 306), and/or the like. In some aspects, the processor 114 may determine a ranking for the restaurants R1-R3 based on the user preferences and other details such as distance from the gym, traffic details, etc., and output the recommendation on the HMI 202 based on the ranking.

In addition, the processor 114 may determine that the vehicle user typically visits a coffee shop of a specific brand. In such cases, the processor 114 may determine the recommendation described above based on the user's preference of the specific brand. In some aspects, in such cases, the processor 114 may obtain and compare charging services offered by different stores of the same brand, correlate the information associated with the charging services with the user preferences, and identify an optimal destination based on the correlation. The processor 114 may continue to track the vehicle 102 location and provide additional recommendations based on the destinations visited by the vehicle 102. For example, the processor 114 may determine that the vehicle 102 has not visited the restaurants R1-R3, and may be visiting another destination from another tag. Responsive to such determination, the processor 114 may predict the next destination and provide another recommendation to the vehicle user based on the user preferences and routine travel behavior. In some aspects, the processor 114 may update the recommendations based on user's acceptance/rejection of the recommendations displayed on the HMI 202.

Furthermore, as briefly described above, the processor 114 may determine a route that the vehicle 102 is expected to travel in the preset time duration (e.g., on the day) based on the estimation of the expected set of destinations 108, and may identify the optimal set of destinations 110 in the same determined route or in proximity to the determined route. In addition, the processor 114 may identify a parking location in the route based on the user preferences. The processor 114 may further generate a recommendation based on the parking location.

Furthermore, the processor 114 may determine additional one or more routes based on the user preferences. Each route may include respective destinations in the first destination tag, the second destination tag and the third destination tag, and the additional routes may be different from the determined route described above. In this case, the processor 114 may generate the recommendation based on the determined additional routes, and display the recommendation on the HMI 202. In some aspects, the processor 114 may display the route and the additional routes on the user interface/HMI 202 in a specific order/rank, which may be based on the user preferences. Responsive to displaying the routes on the HMI 202, The processor 114 may obtain a user selection for a preferred route, and cause the vehicle 102 to move in the selected route (e.g., by autonomously moving the vehicle 102).

Although the description above describes an aspect where the processor 114 optimizes vehicle charging, the present disclosure is not limited to such an aspect. In additional aspects, the processor 114 may identify optimal discharging locations (e.g., when the vehicle 102 has bidirectional capabilities) in the similar manner the processor 114 identifies the optimal charging locations, and provide recommendations to visit such destinations/locations. In an exemplary aspect, the optimal discharging locations may offer incentives/rewards for discharging the vehicle 102.

The vehicle 102 and the system 104 implement and/or perform operations, as described here in the present disclosure, in accordance with the owner manual and safety guidelines. In addition, any action taken by the user associated with the vehicle 102 based on the notifications/recommendations provided by the system 104 should comply with all the rules specific to the location and operation of the vehicle 102 (e.g., Federal, state, country, city, etc.). The notifications/recommendations, as provided by the system 104, should be treated as suggestions and only followed according to any rules specific to the location and operation of the vehicles 102.

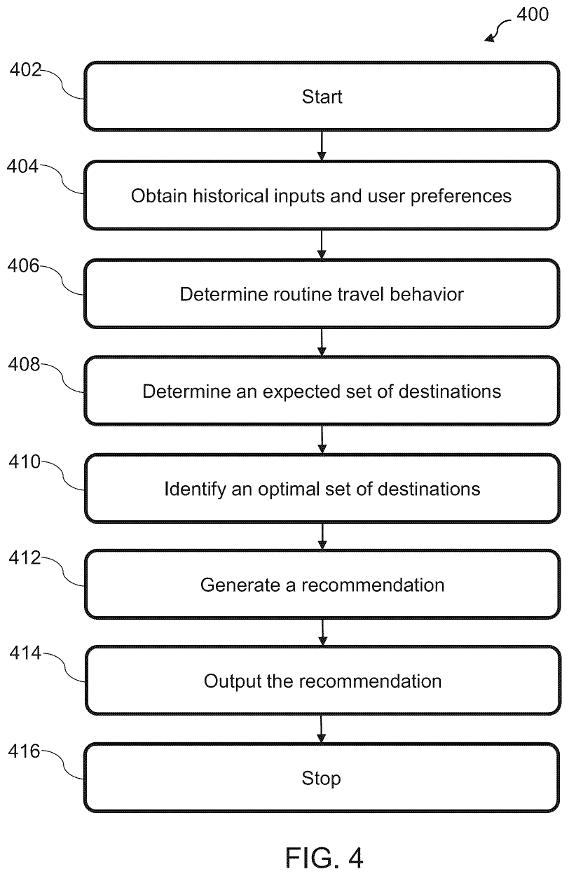

FIG. 4 depicts a flow diagram of an example method for optimizing vehicle movement and vehicle charging in accordance with the present disclosure. FIG. 4 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 400 starts at step 402. At step 404, the method 400 may include obtaining, by the processor 114, the historical inputs associated with the vehicle 102 and the user preferences associated with the vehicle user. The historical inputs may include the historical travel pattern, the historical charging pattern, the historical parking pattern, and/or the like. The user preferences may include preferences associated with high charging speed, reduced charging rates, charger reliability, charger availability, dedicated charging stations, rewarding destination (that may provide reward or incentive to the vehicle user), etc. In addition, the user preferences may include user interests to visit a specific/predefined destination (e.g., a preference for a store of a specific brand over other brands).

At step 406, the method 400 may include determining, by the processor 114, the routine travel behavior of the vehicle 102 based on the historical inputs. The routine travel behavior may include the travel pattern, the charging pattern, the parking pattern, and/or the like associated with the vehicle 102. At step 408, the method 400 may include determining, by the processor 114, the expected set of destinations 108 from the plurality of destinations that the vehicle 102 is expected to visit together/sequentially in a preset time duration (e.g., within a day), based on the routine travel behavior. The plurality of destinations may be associated with the plurality of destination tags, as described above.

At step 410, the method 400 may include identifying, by the processor 114, the optimal set of destinations 110, from the plurality of destinations, based on the user preferences and the routine travel behavior. At step 412, the method 400 may include generating, by the processor 114, a recommendation based on the optimal set of destinations 110. At step 414, the method 400 may include outputting, by the processor 114, the recommendation including the information associated with the optimal set of destinations 110.

At step 416, the method 400 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A system comprising:
a transceiver configured to receive historical inputs associated with a vehicle and user preferences associated with a vehicle user; and
a processor communicatively coupled to the transceiver, wherein the processor is configured to:
determine a routine travel behavior of the vehicle based on the historical inputs, wherein the routine travel behavior comprises a travel pattern, a charging pattern, and a parking pattern;
determine an expected set of destinations from a plurality of destinations that the vehicle is expected to visit in a preset time duration based on the routine travel behavior, wherein the plurality of destinations is associated with a plurality of destination tags, and wherein the expected set of destinations comprises a first destination associated with a first destination tag, of the plurality of destination tags, and a second destination associated with a second destination tag, of the plurality of destination tags;
identify an optimal set of destinations, from the plurality of destinations, based on the user preferences and the routine travel behavior, wherein the optimal set of destinations comprises a third destination associated with the first destination tag and a fourth destination associated with the second destination tag;
generate a recommendation based on the optimal set of destinations; and
output the recommendation comprising the information associated with the optimal set of destinations.

2. The system of claim 1, wherein the historical inputs comprise historical travel pattern, historical charging pattern, and historical parking pattern.

3. The system of claim 1, wherein the user preferences comprise at least one of a preference associated with a high charging speed, reduced charging rates, a charger availability, a charger reliability, or an incentive associated with vehicle charging.

4. The system of claim 1, wherein the user preferences comprise a preference to visit a predefined destination.

5. The system of claim 1, wherein the processor is further configured to:
identify a destination type of each of the plurality of destinations;
categorize the plurality of destinations into the plurality of destination tags based on the destination type; and
store a mapping of the plurality of destinations with the plurality of destination tags in a system memory.

6. The system of claim 5, wherein the processor is further configured to:
obtain the mapping from the system memory;
determine a first group of destinations from the plurality of destinations associated with the first destination tag, and a second group of destinations from the plurality of destinations associated with the second destination tag based on the mapping, wherein the first destination tag is different from the second destination tag; and
determine the third destination from the first group of destinations and the fourth destination from the second group of destinations based on the user preferences and the routine travel behavior.

7. The system of claim 6, wherein the processor is further configured to:
obtain the information associated with charging services of the first group of destinations and the second group of destinations;
correlate the information associated with charging services with the user preferences; and
determine the third destination and the fourth destination based on the correlation.

8. The system of claim 1, wherein the first destination is different from the third destination, or the second destination is different from the fourth destination.

9. The system of claim 1, wherein the processor is further configured to:
determine most visited destinations, from the plurality of destinations, associated with the vehicle based on the routine travel behavior; and
determine the expected set of destinations from the most visited destinations based on the routine travel behavior.

10. The system of claim 9, wherein the processor is further configured to:
estimate a probability of parking the vehicle at each of the most visited destinations at each time based on the routine travel behavior;
set a threshold to ascertain a parking event at each destination;
determine that the probability of parking at the first destination at a future time slot is greater than the threshold; and
determine that the vehicle is expected to park at the first destination during the future time slot based on a determination that the probability is greater than the threshold.

11. The system of claim 10, wherein the processor is further configured to:
predict the second destination and the second destination tag that the vehicle is expected to visit after the first destination, based on the routine travel behavior; and
estimate the expected set of destinations based on the prediction of the second destination and the determination that the vehicle is expected to park at the first destination.

12. The system of claim 11, wherein the processor is further configured to:
identify the fourth destination associated with the second destination tag based on the user preferences and the routine travel behavior in real-time, responsive to determining that the vehicle is parked at the first destination; and
generate the recommendation to visit the fourth destination responsive to identifying the fourth destination; and
output the recommendation comprising the information associated with the fourth destination.

13. The system of claim 1, wherein the processor is further configured to:
determine a routine charging destination from the expected set of destinations based on the routine travel behavior;
determine an updated charging destination from the optimal set of destinations based on the user preferences; and
generate the recommendation comprising the information associated with the updated charging destination.

14. The system of claim 1, wherein the processor is further configured to:
estimate a sequence to visit the expected set of destinations; and
generate the recommendation based on the sequence and the user preferences, wherein the recommendation comprises an updated sequence to visit the expected set of destinations.

15. The system of claim 1, wherein the processor is further configured to:
determine a route that the vehicle is expected to travel in the preset time duration based on the expected set of destinations; and
identify the optimal set of destinations in the route based on the user preferences and the routine travel behavior.

16. The system of claim 15, wherein the processor is further configured to:
identify a parking location in the route based on the user preferences; and
generate the recommendation based on the parking location.

17. The system of claim 15, wherein the processor is further configured to:
determine one or more additional routes based on the user preferences and the routine travel behavior, wherein each additional route comprises respective destinations in the first destination tag and the second destination tag, and wherein the one or more additional routes are different from the route; and
generate the recommendation based on the one or more additional routes.

18. The system of claim 17, wherein the processor is further configured to:
display the information associated with the route and the one or more additional routes on a user interface;
obtain a user selection of a preferred route responsive to displaying the information associated with the route and the one or more additional routes; and
cause the vehicle to move in the preferred route responsive to obtaining the user selection.

19. A method comprising:
obtaining, by a processor, historical inputs associated with a vehicle and user preferences associated with a vehicle user;
determining, by the processor, a routine travel behavior of the vehicle based on the historical inputs, wherein the routine travel behavior comprises a travel pattern, a charging pattern, and a parking pattern;
determining, by the processor, an expected set of destinations from a plurality of destinations that the vehicle is expected to visit in a preset time duration based on the routine travel behavior, wherein the plurality of destinations is associated with a plurality of destination tags, and wherein the expected set of destinations comprises a first destination associated with a first destination tag, of the plurality of destination tags, and a second destination associated with a second destination tag, of the plurality of destination tags;
identifying, by the processor, an optimal set of destinations, from the plurality of destinations, based on the user preferences and the routine travel behavior, wherein the optimal set of destinations comprises a third destination associated with the first destination tag and a fourth destination associated with the second destination tag;
generating, by the processor, a recommendation based on the optimal set of destinations; and
outputting, by the processor, the recommendation comprising the information associated with the optimal set of destinations.

20. A non-transitory computer-readable storage medium having instructions stored thereupon which, when executed by a processor, cause the processor to:
obtain historical inputs associated with a vehicle and user preferences associated with a vehicle user;
determine a routine travel behavior of the vehicle based on the historical inputs, wherein the routine travel behavior comprises a travel pattern, a charging pattern, and a parking pattern;
determine an expected set of destinations from a plurality of destinations that the vehicle is expected to visit in a preset time duration based on the routine travel behavior, wherein the plurality of destinations is associated with a plurality of destination tags, and wherein the expected set of destinations comprises a first destination associated with a first destination tag, of the plurality of destination tags, and a second destination associated with a second destination tag, of the plurality of destination tags;
identify an optimal set of destinations, from the plurality of destinations, based on the user preferences and the routine travel behavior, wherein the optimal set of destinations comprises a third destination associated with the first destination tag and a fourth destination associated with the second destination tag;
generate a recommendation based on the optimal set of destinations; and
output the recommendation comprising the information associated with the optimal set of destinations.
